(19) United States
(12) Patent Application Publication
(10) Pub. No.: US 2020/0335860 A1
(43) Pub. Date: Oct. 22, 2020

(54) ANTENNA

(71) Applicant: FUJIKURA LTD., Tokyo (JP)

(72) Inventors: Yuta Hasegawa, Sakura-shi (JP); Ning Guan, Sakura-shi (JP)

(73) Assignee: FUJIKURA LTD., Tokyo (JP)

(21) Appl. No.: 16/954,616

(22) PCT Filed: Oct. 5, 2018
(86) PCT No.: PCT/JP2018/037375

§ 371 Date: Jun. 17, 2020

(30) Foreign Application Priority Data
Jan. 19, 2018 (JP) 2018-006892

(51) Int. Cl. H01Q 1/38; H01Q 1/40; H01Q 13/08; H01Q 21/06

(52) U.S. Cl. CPC H01Q 1/38; H01Q 21/065; H01Q 13/08; H01Q 1/40

(57) ABSTRACT

To stabilize radiation characteristics of a radiation element by reducing bending deformation of the radiation element and widen a band of an antenna. An antenna includes: a first flexible dielectric layer; a conductive pattern layer formed on a surface of the first dielectric layer; a second flexible dielectric layer joined to the first dielectric layer on a side opposite to the conductive pattern layer with respect to the first dielectric layer; a conductive ground layer formed between the first dielectric layer and the second dielectric layer; a rigid dielectric substrate joined to the second dielectric layer on a side opposite to the conductive ground layer with respect to the second dielectric layer; and an antenna pattern layer formed between the second dielectric layer and the dielectric substrate and including one or more radiation elements, the conductive pattern layer including a feed line for supplying electric power to the radiation elements.

### TECHNICAL FIELD

The present disclosure relates to an antenna.

### BACKGROUND ART

In recent years, the usable band and frequency of a transmission signal have been rapidly widen and risen, with a rapid increase in wireless communication capacity. This has been widening the usable frequency from a microwave band of 0.3 to 30 GHz to a millimeter wave band of 30 to 300 GHz. In a band of 60 GHz, although a transmission signal is greatly attenuated in the air, there are advantages as follows. The first advantage is that communication data are less likely to leak. The second advantage is that it is possible to dispose multiple communication cells by reducing the size of communication cells. The third advantage is that a communication band is a broad band, which enables large-capacity communication. These advantages draw attention to the band of 60 GHz. However, since a transmission signal is greatly attenuated, a broadband antenna having high directivity and gain has been demanded. In particular, an array antenna including a plurality of radiation elements arranged at short pitches has been actively researched.

Patent Literature 1 discloses an antenna in which a dielectric layer is joined to a conductive ground layer, a plurality of radiation elements and microstrip feed lines are formed, and dielectric layers for space impedance conversion coat the radiation elements and the microstrip feed lines.

### CITATION LIST

### Patent Literature

[Patent Literature 1] Japanese Patent Application Publication No. H6-29723

### SUMMARY OF INVENTION

### Technical Problem

To transmit a signal wave using the microstrip feed lines, the dielectric layer needs to be sufficiently thin with respect to a wavelength. The thin dielectric layer is flexible, which causes bending deformation. In association therewith, bending deformation of the radiation elements also occur, and this changes radiation characteristics of the radiation elements. Further, such a thin dielectric layer narrows a band of an antenna.

Thus, the present disclosure has been achieved in view of the circumstances described above. An object of the present disclosure is to stabilize radiation characteristics of a radiation element by reducing bending deformation of the radiation element and to widen a band of an antenna.

### Solution to Problem

A primary aspect of the present disclosure to achieve the aforementioned object is an antenna comprising: a first dielectric layer; a conductive pattern layer formed on a surface of the first dielectric layer; a second dielectric layer joined to the first dielectric layer on a side opposite to the conductive pattern layer with respect to the first dielectric layer; a conductive ground layer formed between the first dielectric layer and the second dielectric layer; a dielectric substrate joined to the second dielectric layer on a side opposite to the conductive ground layer with respect to the second dielectric layer; and an antenna pattern layer formed between the second dielectric layer and the dielectric substrate, the antenna pattern layer including one or more radiation elements, the conductive pattern layer including a feed line for supplying electric power to the radiation elements, the first and second dielectric layers being flexible, the dielectric substrate being rigid.

Other features of the present disclosure are made clear from the following description and the drawings.

### Advantageous Effects of Invention

According to the present disclosure, bending deformation of a radiation element can be reduced, and radiation characteristics of the radiation element are stabilized and less likely to change.

It is possible to reduce losses in the feed line and the radiation element by making first and second dielectric layers thin, while a band of an antenna can be suppressed from being narrowed by disposing a dielectric substrate on the radiation element.

### BRIEF DESCRIPTION OF DRAWINGS

FIG. 1 is a cross-sectional view of an antenna according to a first embodiment.

FIG. 2 is a cross-sectional view of an antenna according to a first modification example of a first embodiment.

FIG. 3 is a cross-sectional view of an antenna according to a second modification example of a first embodiment.

FIG. 4 is a cross-sectional view of an antenna according to a third modification example of a first embodiment.

FIG. 5 is a cross-sectional view of an antenna according to a fourth modification example of a first embodiment.

FIG. 6 is a plan view of an antenna according to a second embodiment.

FIG. 7 is a cross-sectional view of a cut place taken along VII-VII of FIG. 6.

FIG. 8 is a graph illustrating a simulation result of a gain of an antenna according to a second embodiment.

FIG. 9 is a graph illustrating a simulation result of a gain of an antenna according to a second embodiment.

FIG. 10 is a plan view of an antenna according to a first modification example of a second embodiment.

FIG. 11 is a plan view of an antenna according to a second modification example of a second embodiment.

FIG. 12 is a plan view of an antenna according to a third embodiment.

FIG. 13 is a plan view of an antenna according to a fourth embodiment.

FIG. 14 is a plan view of an antenna according to a fifth embodiment.

FIG. 15 is a plan view of an antenna according to a modification example of a third embodiment.

### DESCRIPTION OF EMBODIMENTS

At least the following matters are made clear from the following description and the drawings.

An antenna comprising: a first dielectric layer; a conductive pattern layer formed on a surface of the first dielectric layer; a second dielectric layer joined to the first dielectric layer on a side opposite to the conductive pattern layer with respect to the first dielectric layer; a conductive ground layer formed between the first dielectric layer and the second dielectric layer; a dielectric substrate joined to the second dielectric layer on a side opposite to the conductive ground layer with respect to the second dielectric layer; and an antenna pattern layer formed between the second dielectric layer and the dielectric substrate, the antenna pattern layer including one or more radiation elements, the conductive pattern layer including a feed line for supplying electric power to the radiation elements, the first and second dielectric layers being flexible, the dielectric substrate being rigid.

As described above, even when the first and second dielectric layers are flexible, the dielectric substrate is rigid, and thus bending deformation of the radiation elements can be reduced. For this reason, the radiation characteristics of the radiation elements are stabilized and less likely to change.

Since the dielectric substrate is rigid, the first and second dielectric layers can be made thin. By making the first dielectric layer thin, a radiation loss of a signal wave in the feed line can be suppressed. By virtue of the dielectric substrate on the radiation elements, the antenna has a low quality factor and a wide band. Even if the second dielectric substrate is thin, a band of the antenna is suppressed from being narrowed.

A thickness of the dielectric substrate is 300 to 700 μm.

Accordingly, the directivity in a normal direction of a surface of the dielectric substrate is high, and a gain in the normal direction is high.

A sum of thicknesses of the first and second dielectric layers is equal to or less than 250 μm.

Four, six, or eight of the radiation elements are linearly arranged at intervals and connected in series, and electric power is supplied through the feed line to the center of a row of the radiation elements.

Accordingly, an improvement in gain of the antenna can be achieved.

Two rows of the radiation elements are linearly arranged in line, and one of the radiation element rows has a shape that is line symmetric or point symmetric with a shape of another of the radiation element rows, or has a shape obtained by moving the other radiation element row in parallel.

Accordingly, an improvement in gain of the antenna can be achieved.

A plurality of the radiation element rows are arranged at a predetermined pitch in a direction orthogonal to a direction of the radiation element rows, and radiation elements positioned in the same order in the radiation element rows are arranged in line in the orthogonal direction.

Accordingly, an improvement in gain of the antenna can be achieved.

The predetermined pitch is 2 to 2.5 mm.

A plurality of groups are provided, the groups each including the plurality of radiation element rows arranged at the predetermined pitch in the direction orthogonal to the direction of the radiation element rows, and directions of the radiation element rows in all of the groups are parallel to each other.

The antenna further comprises an adhesive layer of a dielectric formed between the second dielectric layer and the dielectric substrate so as to coat the radiation elements, to bond the second dielectric layer and the dielectric substrate together, wherein the adhesive layer is thicker than the radiation elements and thinner than the dielectric substrate.

Accordingly, a void is less likely to be created around the radiation elements at a bonding interface between the adhesive layer and the second dielectric layer. The adhesive layer does not greatly affect radiation characteristics of the radiation element as compared to the dielectric substrate.

The second dielectric layer is a laminate obtained by laminating a plurality of dielectric layers. Accordingly, a multilayer wiring structure can be formed outside a range in which the radiation elements are formed.

### Embodiments

Embodiments of the present disclosure are described below with reference to the drawings. Note that, although various limitations that are technically preferable for carrying out the present disclosure are imposed on the embodiments to be described below, the scope of the present disclosure is not to be limited to the embodiments below and illustrated examples.

### First Embodiment

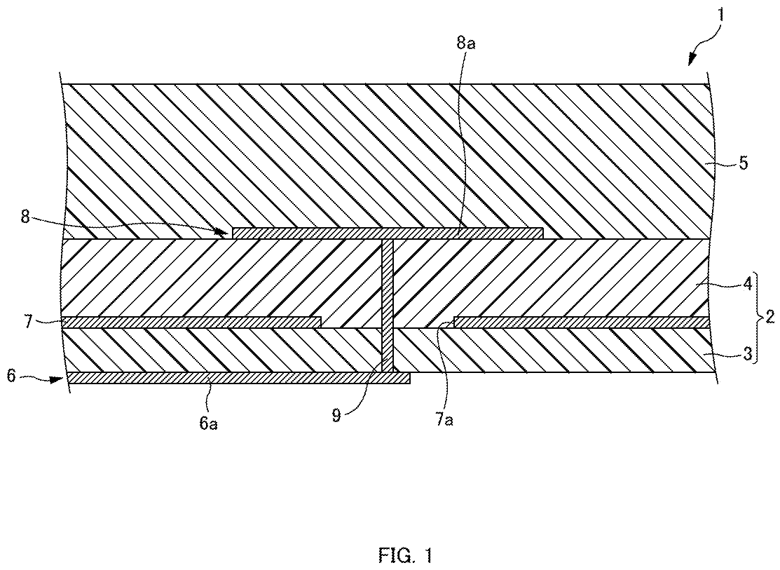

FIG. 1 is a cross-sectional view of an antenna 1 according to a first embodiment . The antenna 1 is used for transmission or reception of a radio wave in a frequency band of a microwave or millimeter wave, or both of the transmission and reception.

A first dielectric layer 3 and a second dielectric layer 4 sandwich a conductive ground layer 7 therebetween and are joined to each other, thereby constituting a flexible dielectric laminate 2.

The conductive ground layer 7 is formed between the first dielectric layer 3 and the second dielectric layer 4.

A conductive pattern layer 6 is formed on a surface of the first dielectric layer 3 on a side opposite to the conductive ground layer 7 with respect to the first dielectric layer 3.

The dielectric laminate 2 and a dielectric substrate 5 sandwich an antenna pattern layer 8 therebetween and are joined to each other. The antenna pattern layer 8 is formed between the dielectric laminate 2 and the dielectric substrate 5. In other words, the antenna pattern layer 8 is formed on a surface of the second dielectric layer 4 on a side opposite to the conductive ground layer 7 with respect to the second dielectric layer 4.

As described above, the conductive pattern layer 6, the first dielectric layer 3, the conductive ground layer 7, the second dielectric layer 4, the antenna pattern layer 8, and the dielectric substrate 5 are laminated in this order.

The conductive pattern layer 6, the conductive ground layer 7, and the antenna pattern layer 8 are made of a conductive metal material such as copper.

The antenna pattern layer 8 is processed and shaped by an additive method, a subtractive method, or the like, thereby forming a patch-type radiation element 8a in the antenna pattern layer 8.

The conductive ground layer 7 is processed and shaped by an additive method, a subtractive method, or the like, thereby forming a slot 7a in the conductive ground layer 7. The slot 7a faces a central part of the radiation element 8a.

The conductive pattern layer 6 is processed and shaped by an additive method, a subtractive method, or the like, thereby forming a feed line 6a in the conductive pattern layer 6. The feed line 6a is a microstrip line arranged from a terminal of a radio frequency integrated circuit (RFIC) to a position facing the slot 7a. One end part of the feed line 6a faces the slot 7a, and the one end part is electrically connected to the radiation element 8a by a through hole 9. The other end part of the feed line 6a is connected to the terminal of the RFIC. Thus, electric power is supplied to the radiation element 8a from the RFIC via the feed line 6a and the through hole 9.

The through hole 9 penetrates the conductive ground layer 7 through the slot 7a. The through hole 9 is insulated from the conductive ground layer 7.

The dielectric layers 3 and 4 are made of a liquid crystal polymer. The dielectric substrate 5 is made of fiber-reinforced resin, and more specifically, glass fiber-reinforced epoxy resin, glass-cloth base epoxy resin, glass-cloth base polyphenylene ether resin, or the like.

The sum of the thickness of the first dielectric layer 3 and the thickness of the second dielectric layer 4 is thinner than the thickness of the dielectric substrate 5. In particular, the sum of the thickness of the first dielectric layer 3 and the thickness of the second dielectric layer 4 is equal to or less than 250 μm.

Since the thickness of the dielectric substrate 5 falls within a range of 300 to 700 μm, the gain of the antenna 1 is high, leading to high directivity in a normal direction of a surface of the dielectric substrate 5.

The dielectric layers 3 and 4 are flexible, and the dielectric substrate 5 is rigid. In other words, flex resistance of the dielectric layers 3 and 4 is sufficiently higher than flex resistance of the dielectric substrate 5, and an elastic modulus of the dielectric substrate 5 is sufficiently greater than an elastic modulus of the dielectric layers 3 and 4. Thus, a laminate formed of the conductive pattern layer 6, the first dielectric layer 3, the conductive ground layer 7, the second dielectric layer 4, the antenna pattern layer 8, and the dielectric substrate 5 is less likely to be bent. In particular, a change in radiation characteristics of the radiation element 8a caused by bending deformation of the radiation element 8a is less likely to occur.

The first dielectric layer 3 is thin, the first dielectric layer 3 has a low dielectric constant and dielectric loss tangent, and the feed line 6a is exposed to the air, and thus a transmission loss of a signal wave in the feed line 6a is low. Further, an electric field is mainly formed between the radiation element 8a and the conductive ground layer 7, and the second dielectric layer 4 has a low dielectric constant and dielectric loss tangent, and thus a loss in the radiation element 8a is low even though the radiation element 8a is covered with the dielectric substrate 5. Accordingly, the antenna 1 has a low Q factor and a wide band. Further, the dielectric substrate 5 is not necessary to be thin, thereby suppressing the band of the antenna 1 from being narrowed. Note that Q factor is also referred to as Quality factor.

When the dielectric substrate 5 is formed of glass-cloth base epoxy resin (particularly, FR4), a bending elastic modulus in a vertical direction is 24.3 GPa, a bending elastic modulus in a lateral direction is 20.0 GPa, a dielectric constant is 4.6, and a dielectric loss tangent is 0.050. Here, the bending elastic moduluses in the vertical direction and the lateral direction are measured by a test method based on a standard of ASTM D 790, and the dielectric constant and the dielectric loss tangent are measured by a test method (frequency: 3 GHz) based on a standard of ASTM D 150.

When the dielectric substrate 5 is made of a glass-cloth base polyphenylene ether resin (particularly, Megtron (registered trademark) 6) manufactured by Panasonic Corporation, a bending elastic modulus in the lateral direction is 18 GPa, a relative dielectric constant (Dk) is 3.4, and a dielectric loss tangent (Df) is 0.0015. Here, the bending elastic modulus in the lateral direction is measured by a test method based on a standard of JIS C 6481, and the relative dielectric constant and the dielectric loss tangent are measured by a test method (frequency: 1 GHz) based on a standard of IPC TM-650 2.5.5.9.

On the other hand, when the dielectric layers 3 and 4 are made of a liquid crystal polymer, a bending elastic modulus is 12152 MPa, a dielectric constant is 3.56, and a dielectric loss tangent is 0.0068. Here, the bending elastic modulus is measured by a test method based on a standard of ASTM D 790, and the dielectric constant and the dielectric loss tangent are measured by a test method (frequency: 10³ Hz) based on a standard of ASTM D 150.

### Modification Examples of First Embodiment

Next, some modifications from the above-described embodiment will be described. Some modifications described below may be combined as much as possible.

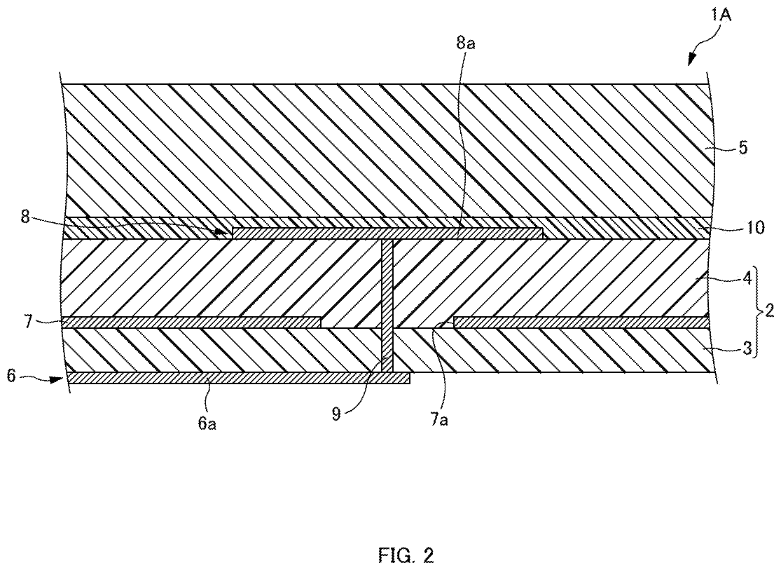

(1) As in an antenna 1A in a modification example illustrated in FIG. 2, the dielectric laminate 2 and the dielectric substrate 5 maybe bonded together with an adhesive layer 10 of a dielectric. The adhesive layer 10 is formed on the surface of the second dielectric layer 4 so as to coat the radiation element 8a, and the second dielectric layer 4 and the dielectric substrate 5 are bonded together with the adhesive layer 10. The adhesive layer 10 facilitates bonding between the second dielectric layer 4 and the dielectric substrate 5.

Since the adhesive layer 10 is thicker than the radiation element 8a, a void is less likely to be created around the radiation element 8a at a bonding interface between the adhesive layer 10 and the second dielectric layer 4.

The adhesive layer 10 is thinner than the dielectric substrate 5, and particularly the thickness of the adhesive layer 10 is equal to or less than 1/10 of the thickness of the dielectric substrate 5. Thus, the adhesive layer 10 does not greatly affect the radiation characteristics of the radiation element 8a as compared to the dielectric substrate 5.

Note that, when the thickness of the dielectric substrate 5 is 300 to 700 μm and the thickness of the radiation element 8a is approximately 12 μm, the thickness of the adhesive layer 10 is preferably 15 to 50 μm.

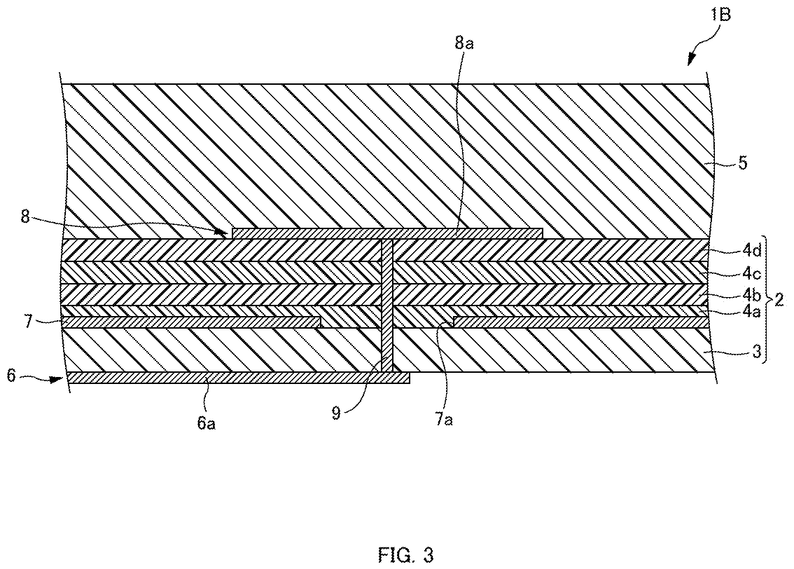

(2) As in an antenna 1B in a modification example illustrated in FIG. 3, the second dielectric layer 4 may be a laminate of flexible dielectric layers 4a to 4d. The dielectric layers 4b and 4d are made of a liquid crystal polymer, and the dielectric layers 4a and 4c are formed of an adhesive material. The dielectric layers 4a to 4d are laminated in this order. The dielectric layer 4a is formed on the surface of the first dielectric layer 3 so as to coat the conductive ground layer 7, and the dielectric layer 4b and the first dielectric layer 3 are bonded together with the dielectric layer 4a. The dielectric layer 4b and the dielectric layer 4d are bonded together with the dielectric layer 4c. The antenna pattern layer 8 is formed on the surface of the second dielectric layer 4, that is, the surface of the dielectric layer 4d.

Since the second dielectric layer 4 is a laminate of the dielectric layers 4a to 4d, a multilayer wiring structure can be formed in the second dielectric layer 4 in a region in which the radiation element 8a is not formed, that is, outside the range illustrated in FIG. 3.

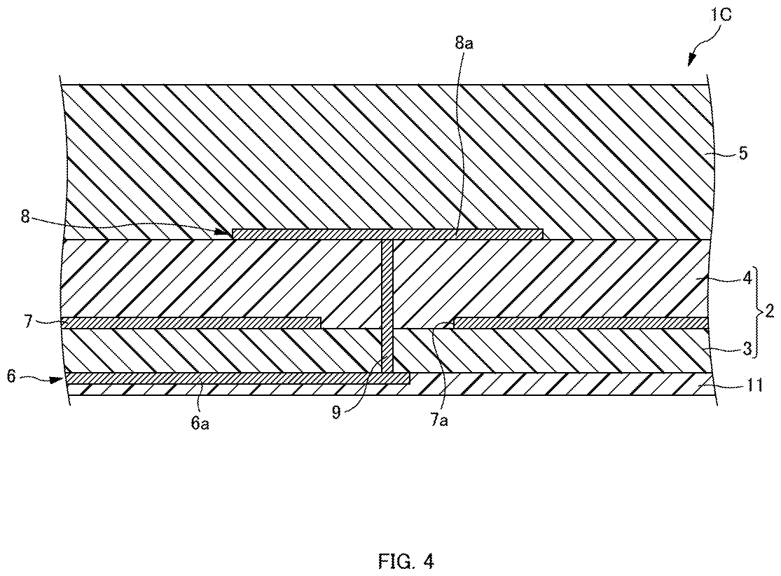

(3) As in an antenna 1C in a modification example illustrated in FIG. 4, a protective dielectric layer 11 may be formed on the surface of the dielectric laminate 2, that is, the surface of the first dielectric layer 3, so as to coat the conductive pattern layer 6. The conductive pattern layer 6 is protected by the protective dielectric layer 11.

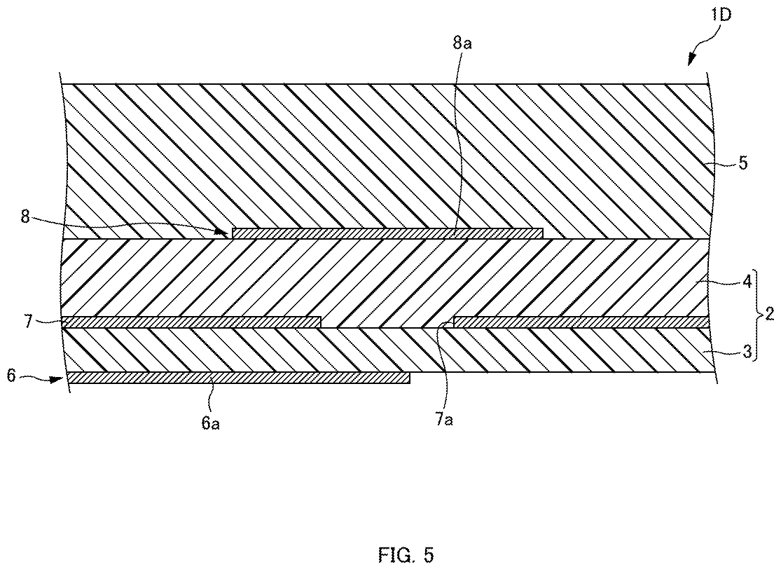

(4) As in an antenna 1D in a modification example illustrated in FIG. 5, one end part of the feed line 6a may be electromagnetically coupled to the radiation element 8a through the slot 7a, without forming a through hole in the dielectric layers 3 and 4.

### Second Embodiment

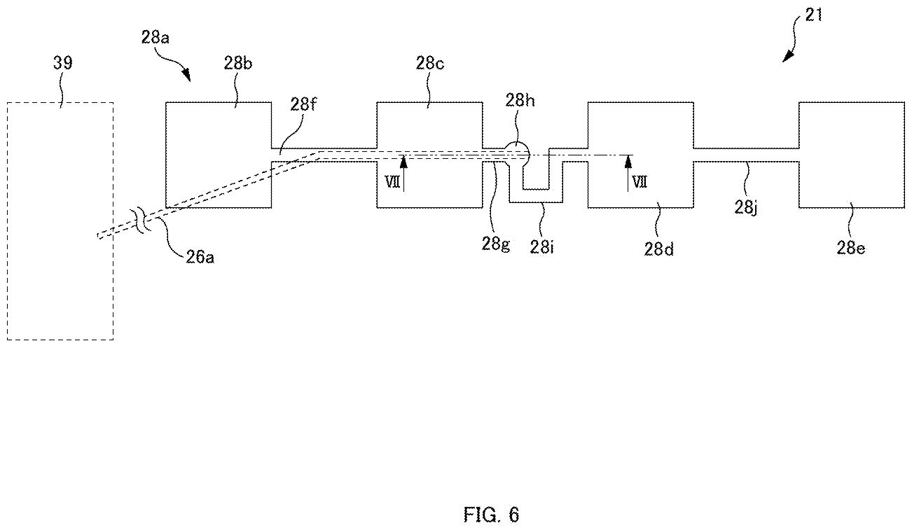

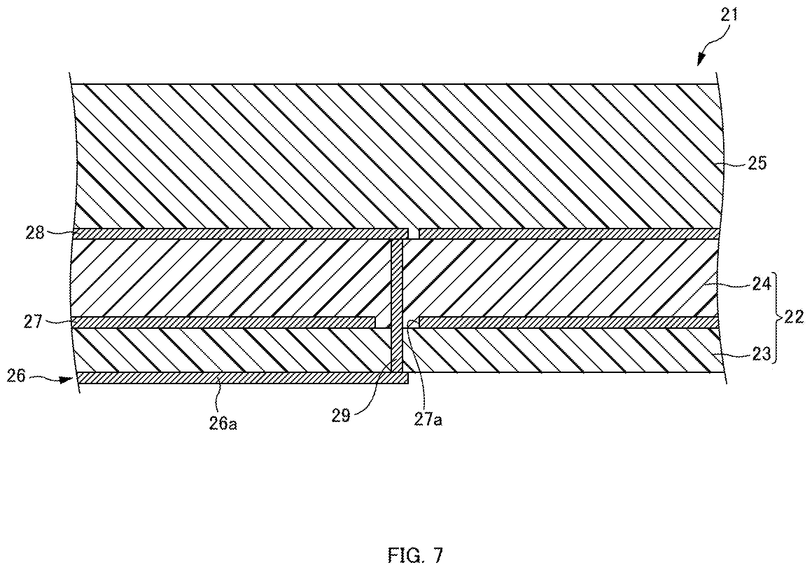

FIG. 6 is a plan view of an antenna 21 according to a second embodiment. FIG. 7 is a cross-sectional view taken along a line VII-VII of FIG. 6. The antenna 21 is used for transmission or reception of a radio wave in a frequency band of a microwave or millimeter wave, or both of the transmission and reception.

A flexible first dielectric layer 23 and a flexible second dielectric layer 24 sandwich a conductive ground layer 27 having conductivity therebetween and are joined to each other, thereby constituting a flexible dielectric laminate 22.

The conductive ground layer 27 is formed between the first dielectric layer 23 and the second dielectric layer 24.

A conductive pattern layer 26 is formed on a surface of the first dielectric layer 23 on a side opposite to the conductive ground layer 27 with respect to the first dielectric layer 23.

The second dielectric layer 24 and a rigid dielectric substrate 25 sandwich an antenna pattern layer 28 therebetween and are joined to each other. The antenna pattern layer 28 is formed between the second dielectric layer 24 and the dielectric substrate 25.

As described above, the conductive pattern layer 26, the first dielectric layer 23, the conductive ground layer 27, the second dielectric layer 24, the antenna pattern layer 28, and the dielectric substrate 25 are laminated in this order.

An RFIC 39 is mounted on the surface of the first dielectric layer 23 on a side opposite to the conductive ground layer 27 with respect to the first dielectric layer 23.

The composition and thickness of the first dielectric layer 23 are the same as the composition and thickness of the first dielectric layer 3 in the first embodiment. The composition and thickness of the second dielectric layer 24 are the same as the composition and thickness of the second dielectric layer 4 in the first embodiment. The composition and thickness of the dielectric substrate 25 are the same as the composition and thickness of the dielectric substrate 5 in the first embodiment. The composition and thickness of the conductive pattern layer 26 are the same as the composition and thickness of the conductive pattern layer 6 in the first embodiment. The composition and thickness of the conductive ground layer 27 are the same as the composition and thickness of the conductive ground layer 7 in the first embodiment. The composition and thickness of the antenna pattern layer 28 are the same as the composition and thickness of the antenna pattern layer 8 in the first embodiment.

The antenna pattern layer 28 is processed and shaped by an additive method, a subtractive method, or the like, thereby forming an element row 28a in the antenna pattern layer 28.

The element row 28a includes patch-type radiation elements 28b to 28e, feed lines 28f, 28g, 28i, and 28j, and a land part 28h.

The radiation elements 28b to 28e are linearly arranged in a row in this order at intervals. Here, the radiation element 28b in the element row 28a is set at a leading end, and the radiation element 28e is set at a tail end.

The radiation elements 28b to 28e are connected in series as follows.

The leading-end radiation element 28b and the second radiation element 28c are connected in series using the feed line 28f provided therebetween. The land part 28h is provided at the center of the element row 28a, that is, between the second radiation element 28c and the third radiation element 28d. The second radiation element 28c and the land part 28h are connected in series using the feed line 28g provided therebetween. The third radiation element 28d and the land part 28h are connected in series using the feed line 28i provided therebetween. The third radiation element 28d and the tail-end radiation element 28e are connected in series using the feed line 28j provided therebetween. The feed lines 28f, 28g, and 28j are formed linearly, and the feed line 28i is bent. The length of the feed line 28g is smaller than the length of the feed lines 28f, 28i, and 28j.

Since the element row 28a includes the four radiation elements 28b to 28e, the gain of the antenna 21 is high.

The conductive ground layer 27 is processed and shaped by an additive method, a subtractive method, or the like, thereby forming a slot 27a in the conductive ground layer 27. The slot 27a faces the center of the element row 28a, that is, the land part 28h.

The conductive pattern layer 26 is processed and shaped by an additive method, a subtractive method, or the like, thereby forming a feed line 26a in the conductive pattern layer 26. The feed line 26a is a microstrip line arranged from a terminal of the RFIC 39 to a position facing the slot 27a. One end part of the feed line 26a faces the slot 27a, and the one end part is electrically connected to the land part 28h by a through hole 29. The other end part of the feed line 26a is connected to the terminal of the RFIC 39. Thus, electric power is supplied to the element row 28a from the RFIC 39 via the feed line 26a and the through hole 29. The through hole 29 penetrates the conductive ground layer 27 through the slot 27a. The through hole 29 is insulated from the conductive ground layer 27.

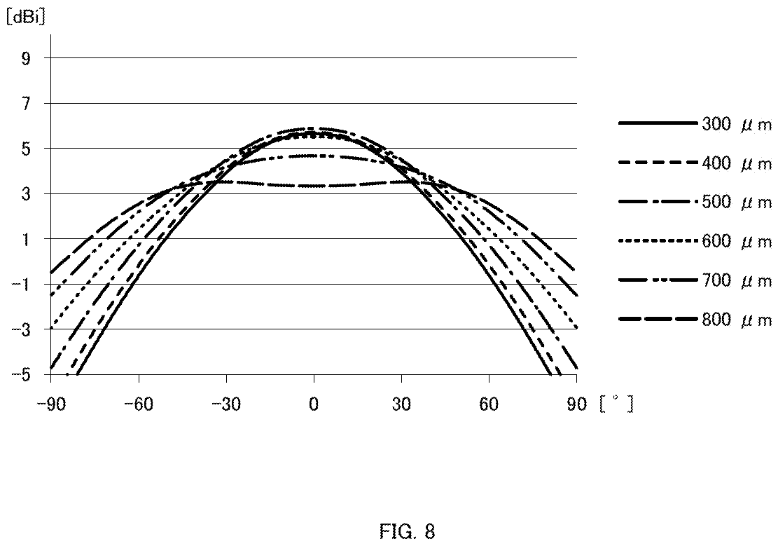

Since the thickness of the dielectric substrate 25 falls within a range of 300 to 700 μm, the gain of the antenna 21 is high, leading to high directivity in a normal direction of a surface of the dielectric substrate 25. FIG. 8 illustrates a result of verifying this. The gain of the antenna 21 when the thickness of the dielectric substrate 25 is 300 μm, 400 μm, 500 μm, 600 μm, 700 μm, and 800 μm is simulated. In FIG. 8, a lateral axis indicates an angle relative to the normal direction of the surface of the dielectric substrate 25, and a vertical axis indicates a gain. When the thickness of the dielectric substrate 25 is 300 μm, 400 μm, 500 μm, 600 μm, and 700 μm, the directivity in the normal direction is high, and all the gains in the normal direction in a range of −30° to 30° are high exceeding 4 dBi. When the thickness of the dielectric substrate 25 is 800 μm, the directivity in the normal direction is low, and gains in the normal direction at all the angles are under 4 dBi. Thus, it is clear that the gain of the antenna 21 and the directivity in the normal direction of the surface of the dielectric substrate 25 is high as long as the thickness of the dielectric substrate 25 falls within a range of 300 to 700 μm.

Since the dielectric substrate 25 is rigid, a laminate formed of the conductive pattern layer 26, the first dielectric layer 23, the conductive ground layer 27, the second dielectric layer 24, the antenna pattern layer 28, and the dielectric substrate 25 is less likely to be bent. In particular, a change in radiation characteristics of the element row 28a caused by bending deformation of the element row 28a is less likely to occur.

The first dielectric layer 23 is thin, the first dielectric layer 23 has a low dielectric constant and dielectric loss tangent, and the feed line 26a is exposed to the air, and thus a transmission loss of a signal wave in the feed line 26a is low. Further, an electric field is formed mainly between the element row 28a and the conductive ground layer 27, and the second dielectric layer 24 has a low dielectric constant and dielectric loss tangent, and thus a loss in the element row 28a is low even through the element row 28a is covered with the dielectric substrate 25. Accordingly, the antenna 21 has a low Q factor and a wide band. Further, the dielectric substrate 25 is not necessary to be thin, which suppresses the band of the antenna 21 from being narrowed.

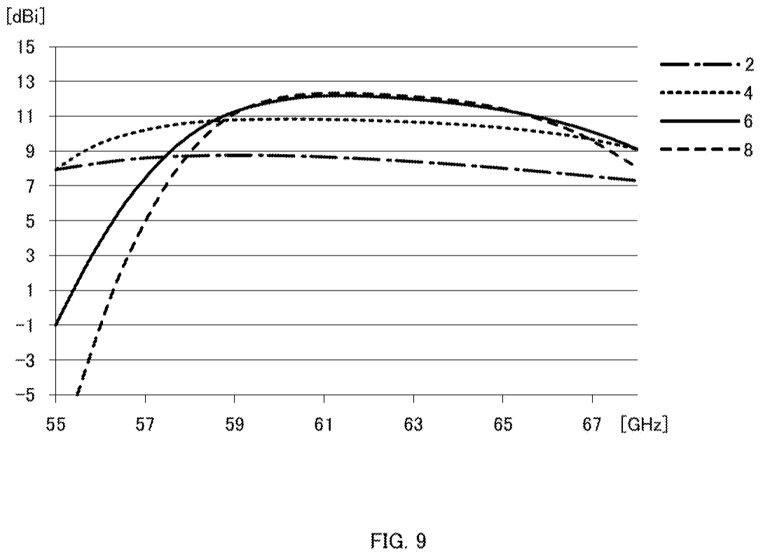

The element row 28a is a series-connection body of the four radiation elements 28b to 28e, but the number of radiation elements is not limited thereto as long as the number is an even number. However, the element row 28a preferably includes four, six, or eight radiation elements. FIG. 9 illustrates a result of verifying this. The gain of the antenna 21 when the number of elements in the element row 28a is two, four, six, and eight is simulated. In FIG. 9, a lateral axis indicates a frequency, and a vertical axis indicates a gain. When the number of elements in the element row 28a is four, six, or eight, a frequency band in which a gain exceeds 9 dBi is wide in a range of 58 to 67 GHz. When the number of elements in the element row 28a is two, a gain does not exceed 9 dBi in a frequency band in a range of 56 to 68 GHz. Thus, it is clear that the number of elements in the element row 28a is preferably four, six, and eight.

### Modification Examples of Second Embodiment

The modifications in the first embodiment may be applied to the second embodiment as in (1) to (4) below.
(1) The dielectric laminate 22 and the dielectric substrate 25 may be bonded together with an adhesive layer of a dielectric.
(2) The second dielectric layer 24 may be a laminate of a plurality of flexible dielectric layers.
(3) A protective dielectric layer may be formed on the surface of the first dielectric layer 23 so as to coat the conductive pattern layer 26.
(4) One end part of the feed line 26a may be electromagnetically coupled to the land part 28h through the slot 27a, without forming a through hole in the dielectric layers 23 and 24.

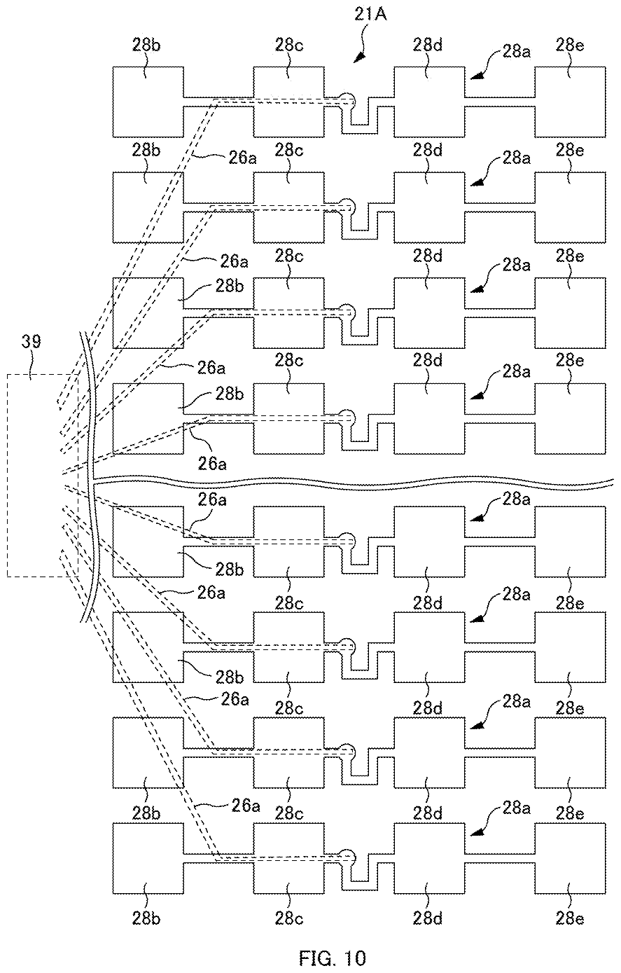

As in an antenna 21A in a modification example illustrated in a plan view of FIG. 10, a plurality of sets (e.g., 16 sets) each including the element row 28a, the feed line 26a, the slot 27a (see. FIG. 7), and the through hole 29 (see. FIG. 7) may be arranged, at predetermined pitches, in a direction orthogonal to the row direction of the element row 28a. In this case, the positions in the row direction of the radiation elements 28b in the respective element rows 28a are aligned, and the radiation elements 28b are arranged in line in the direction orthogonal to the row direction. The same applies to the radiation elements 28c of the respective element rows 28a. The same applies to the radiation elements 28d of the respective element rows 28a. The same applies to the radiation elements 28e of the respective element rows 28a.

A pitch between the element rows 28a adjacent to each other, that is, an interval between the central lines thereof in the row direction is 2 to 2.5 mm. Since the plurality of radiation elements 28b to 28e are arranged in a grid pattern in such a manner, a high gain is achieved.

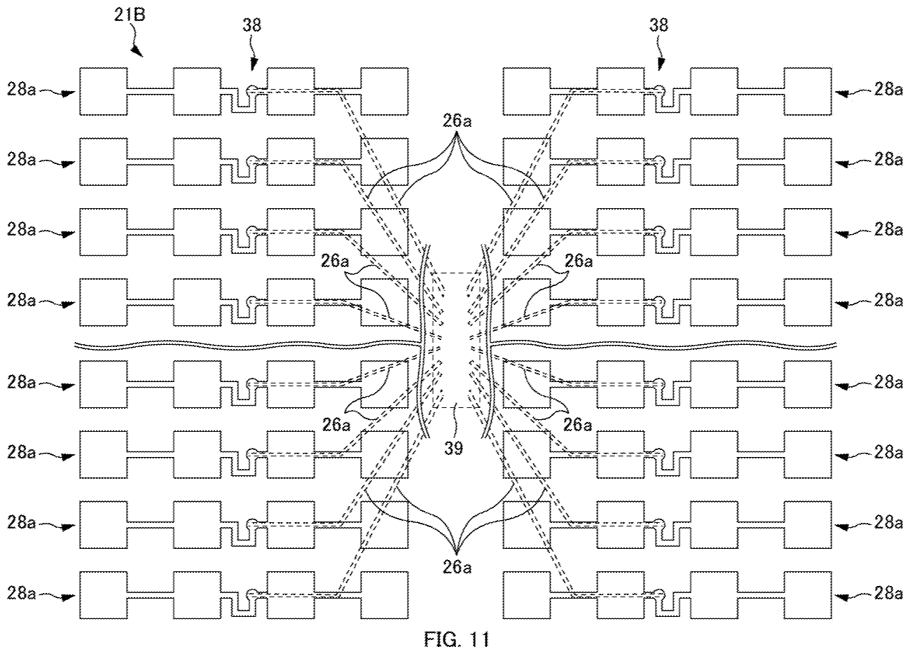

As in an antenna 21B of a modification example illustrated in a plan view of FIG. 11, two groups 38 may be provided, each of which includes a plurality of sets (e.g., 16 sets) each including the element row 28a, the feed line 26a, the slot 27a (see. FIG. 7), and the through hole 29 (see. FIG. 7). In this case, in both of the groups 38, the positions in the row direction of the radiation elements 28b in the respective element rows 28a are aligned, and the radiation elements 28b are arranged in line in the direction orthogonal to the row direction. The same applies to the radiation elements 28c of the respective element rows 28a. The same applies to the radiation elements 28d of the respective element rows 28a. The same applies to the radiation elements 28e of the respective element rows 28a.

In both of the groups 38, a pitch between the element rows 28a adjacent to each other, that is, an interval between the central lines thereof in the row direction is 2 to 2.5 mm. The row direction of the element row 28a in one of the groups 38 is parallel to the row direction of the element row 28a in the other of the groups 38. The RFIC 39 is disposed between the one and the other groups 38. The one group 38 is used for reception, and the other group 38 is used for transmission. Since the plurality of radiation elements 28b to 28e are arranged in a grid pattern in both of the groups 38, a high gain is achieved. Note that both of the groups 38 may be used for reception or may be used for transmission.

Note that three or more groups 38 may be provided. In this case, the row directions of the element rows 28a in all of the groups 38 are parallel to each other. Alternatively, when four groups 38 are provided, the first group 38 and the second group 38 are laterally arranged in the paper plane of FIG. 11 as in FIG. 11, the third group 38 and the fourth group 38 are vertically arranged in the paper plane of FIG. 11, the RFIC 39 is disposed between the first group 38 and the second group 38, the RFIC 39 is disposed between the third group 38 and the fourth group 38, the row direction of the element row 28a of the first group 38 is parallel to the row direction of the element row 28a of the second group 38, and the row direction of the element row 28a of the third and fourth groups 38 is vertical to the row direction of the element row 28a of the first and second groups 38.

### Third Embodiment

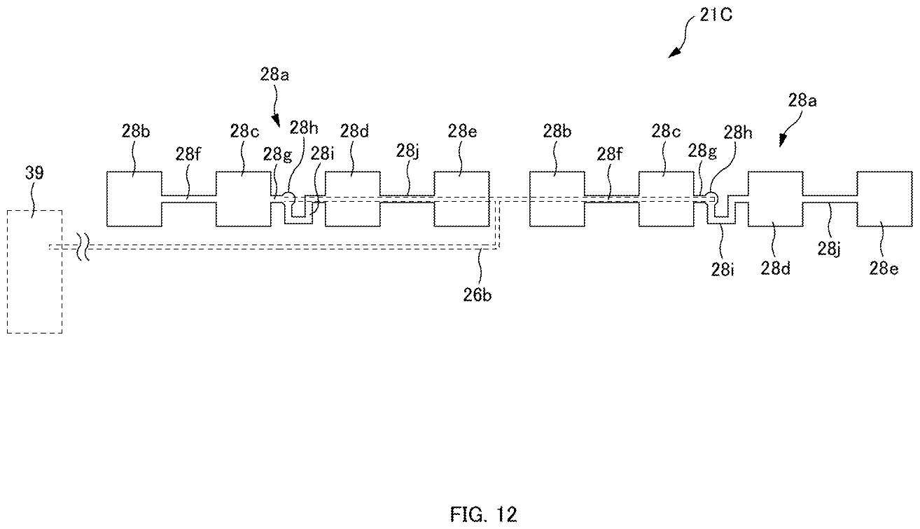

FIG. 12 is a plan view of an antenna 21C according to a third embodiment. Hereinafter, differences between the antenna 21C in the third embodiment and the antenna 21 in the second embodiment will be described, and description of common points will be omitted.

In the antenna 21 in the second embodiment, the antenna pattern layer 28 includes one element row 28a. In contrast, in the antenna 21C in the third embodiment, an antenna pattern layer 28 is processed and shaped by an additive method, a subtractive method, or the like, and thus the antenna pattern layer 28 includes two element rows 28a.

One of the element rows 28a has a shape obtained by moving the other of the element rows 28a in parallel in the row direction. Radiation elements 28b to 28e in the other element row 28a are linearly arranged in line at intervals in the order of the radiation elements 28b, 28c, 28d, and 28e, following a tail-end radiation element 28e in the one element row 28a. Accordingly, the radiation elements 28b to 28e in these element rows 28a are linearly arranged.

A conductive pattern layer 26 is processed and shaped by an additive method, a subtractive method, or the like, and the conductive pattern layer 26 includes a T-branch feed line 26b. The feed line 26b branches into two from an RFIC 39 to land parts 28h in the two element rows 28a, and two branched end parts face the land parts 28h in the two element rows 28a, respectively. Then, similarly to the second embodiment, slots 27a are respectively formed in parts of a conductive ground layer 27 facing the two branched end parts of the feed line 26b, and the two branched end parts of the feed line 26b are electrically connected to the land parts 28h in the two element rows 28a, respectively, by through holes 29 penetrating dielectric layers 23 and 24. Note that the two branched end parts of the feed line 26b may be electromagnetically coupled to the land parts 28h in the two element rows 28a, respectively, through the respective slots 27a.

An electrical length from a terminal of the RFIC 39 to the land part 28h in the one element row 28a along the feed line 26b is equal to an electrical length from the terminal of the RFIC 39 to the land part 28h in the other element row 28a along the feed line 26b.

### Fourth Embodiment

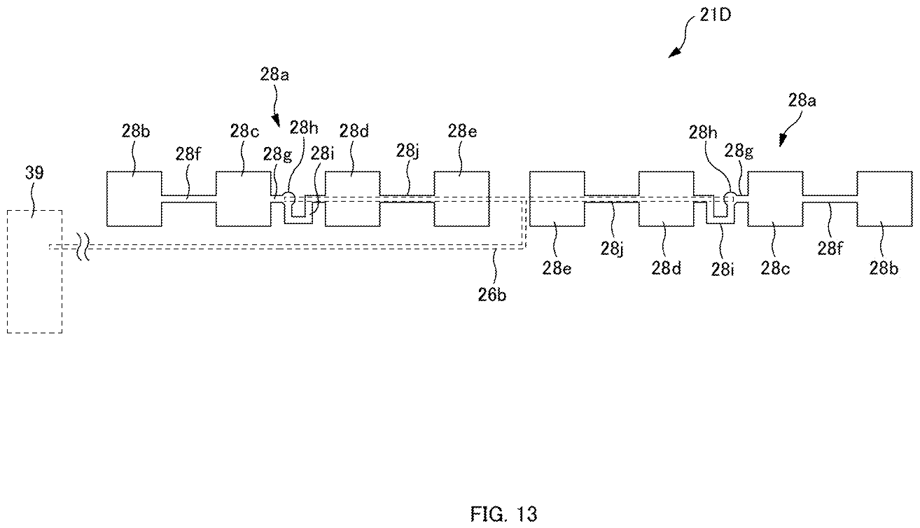

FIG. 13 is a plan view of an antenna 21D according to a fourth embodiment. Hereinafter, differences between the antenna 21D in the fourth embodiment and the antenna 21C in the third embodiment will be described, and description of common matters will be omitted.

In the antenna 21C in the third embodiment, one of the element rows 28a has a shape obtained by moving the other of the element rows 28a in parallel in the row direction. In contrast, in the antenna 21D in the fourth embodiment, the one element row 28a has a shape that is line symmetric with the shape of the other element row 28a with respect to a symmetric line orthogonal to the row direction of the other element row 28a. Radiation elements 28e to 28b in the other element row 28a are linearly arranged in line at intervals in the order of the radiation elements 28e, 28d, 28c, and 28b, following a tail-end radiation element 28e in the one element row 28a. Accordingly, the radiation elements 28b to 28e in these element rows 28a are linearly arranged.

A difference between an electrical length from a terminal of an RFIC 39 to a land part 28h in the one element row 28a along a feed line 26b and an electrical length from the terminal of the RFIC 39 to a land part 28h in the other element row 28a along the feed line 26b is equal to a half of an effective wavelength at the center of a band to be used.

### Fifth Embodiment

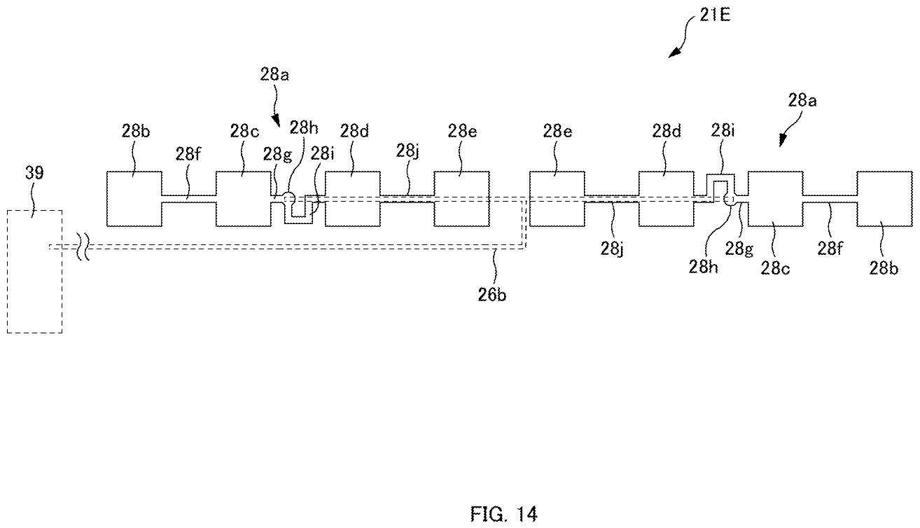

FIG. 14 is a plan view of an antenna 21F according to a fifth embodiment. Hereinafter, differences between the antenna 21F in the fifth embodiment and the antenna 21C in the third embodiment will be described, and description of common matters will be omitted.

In the antenna 21C in the third embodiment, the one element row 28a has a shape obtained by moving the other element row 28a in parallel in the row direction. In contrast, in the antenna 21F in the fifth embodiment, one of element rows 28a and the other of element row 28a have point symmetry. Radiation elements 28e to 28b in the other element row 28a are linearly arranged in line at intervals in the order of the radiation elements 28e, 28d, 28c, and 28b, following a tail-end radiation element 28e in the one element row 28a. Accordingly, the radiation elements 28b to 28e in these element rows 28a are linearly arranged.

A difference between an electrical length from a terminal of an RFIC 39 to a land part 28h in the one element row 28a along a feed line 26b and an electrical length from the terminal of the RFIC 39 to a land part 28h in the other element row 28a along the feed line 26b is equal to a half of an effective wavelength at the center of a band to be used.

Modification Examples of Third to Fifth Embodiments:

The modifications in the first embodiment may be applied to the third to fifth embodiments as in (1) to (4) below.

(1) The dielectric laminate 22 and the dielectric substrate 25 may be bonded together with an adhesive layer of a dielectric.

(2) The second dielectric layer 24 may be a laminate of a plurality of flexible dielectric layers.

(3) A protective dielectric layer may be formed on the surface of the first dielectric layer 23 so as to coat the conductive pattern layer 26.

(4) The two branched end parts of the feed line 26b may be electromagnetically coupled to the land parts 28h in the two element rows 28a through the slots 27a, respectively, without forming through holes in the dielectric layers 23 and 24.

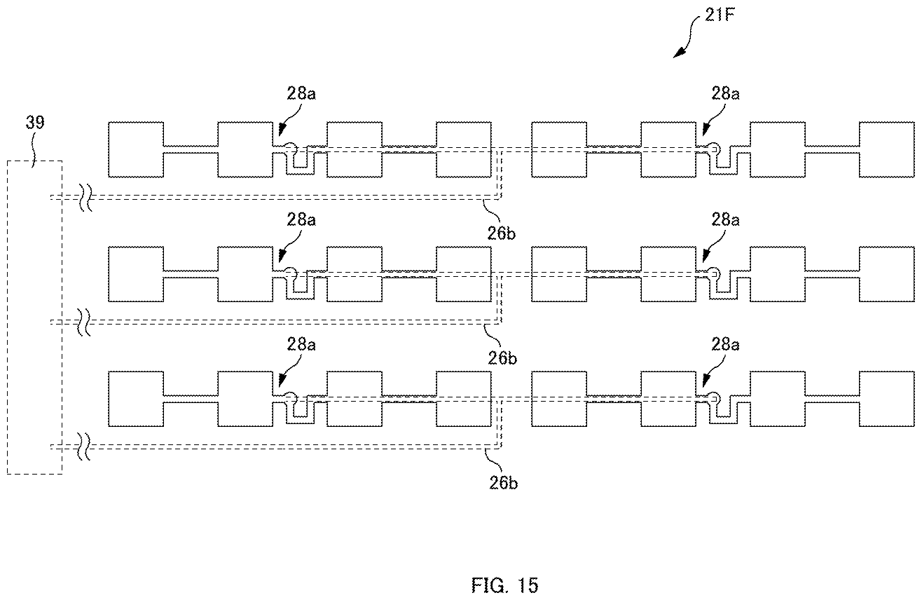

As in an antenna 21F in a modification example illustrated in a plan view of FIG. 15, sets each including the two element rows 28a, the feed line 26b, the slot 27a (see. FIG. 7), and the through hole 29 (see. FIG. 7) may be arranged in a direction orthogonal to the row direction of the element row 28a at predetermined pitches (e.g., 2 to 2.5 mm). In this case, radiation elements positioned in the same order and the same position, when counting from the leading end of the two element rows 28a in each of the sets, are aligned in the row direction, and the radiation elements are arranged in line in the direction orthogonal to the row direction.

FIG. 15 is a plan view of the antenna 21F in the modification example of the third embodiment. In modification examples of the fourth and fifth embodiments as well, sets each including the two element rows 28a, the feed line 26b, the slot 27a (see. FIG. 7), and the through hole 29 (see. FIG. 7) maybe arranged at a predetermined pitch (e.g. , 2 to 2.5 mm) in the direction orthogonal to the row direction of the element row 28a, similarly to the modification example of the third embodiment.

Two groups may be provided, each of which (see. FIG. 15) includes a plurality of sets (e.g., 16 sets) each including the two element rows 28a, the feed line 26b, the slot 27a (see. FIG. 7), and the through hole 29 (see. FIG. 7). The row directions of the element rows 28a in all of the groups are parallel to each other.

### REFERENCE SIGNS LIST

1, 1A, 1B, 1C, 1D: Antenna;
21, 21A, 21B, 21C, 21D, 21E, 21F: Antenna;
3, 23: First dielectric layer;
4, 24: Second dielectric layer;
4a, 4b, 4c, 4d: Dielectric layer;
5, 25: Dielectric substrate;
6, 26: Conductive pattern layer;
6a, 26a, 26b: Feed line;
7, 27: Conductive ground layer;
7a, 27a: Slot;
8, 28: Antenna pattern layer;
8a, 28b, 28c, 28d, 28e: Radiation element;
28a: Element row;
38: Group.

1. An antenna comprising:
a first dielectric layer;
a conductive pattern layer formed on a surface of the first dielectric layer;
a second dielectric layer joined to the first dielectric layer on a side opposite to the conductive pattern layer with respect to the first dielectric layer;
a conductive ground layer formed between the first dielectric layer and the second dielectric layer;
a dielectric substrate joined to the second dielectric layer on a side opposite to the conductive ground layer with respect to the second dielectric layer; and
an antenna pattern layer formed between the second dielectric layer and the dielectric substrate,
the antenna pattern layer including one or more radiation elements, the conductive pattern layer including a feed line for supplying electric power to the radiation elements, the first and second dielectric layers being flexible, the dielectric substrate being rigid.

2. The antenna according to claim 1, wherein
a thickness of the dielectric substrate is 300 to 700 μm.

3. The antenna according to claim 1, wherein
a sum of thicknesses of the first and second dielectric layers is equal to or less than 250 μm.

4. The antenna according to claim 1, wherein
four, six, or eight of the radiation elements are linearly arranged at intervals and connected in series, and
electric power is supplied through the feed line to the center of a row of the radiation elements.

5. The antenna according to claim 4, wherein
two rows of the radiation elements are linearly arranged in line, and one of the radiation element rows has a shape that is line symmetric or point symmetric with a shape of another of the radiation element rows, or has a shape obtained by moving the other radiation element row in parallel.

6. The antenna according to claim 4, wherein
a plurality of the radiation element rows are arranged at a predetermined pitch in a direction orthogonal to a direction of the radiation element rows, and radiation elements positioned in the same order in the radiation element rows are arranged in line in the orthogonal direction.

7. The antenna according to claim 6, wherein
the predetermined pitch is 2 to 2.5 mm.

8. The antenna according to claim 6, wherein
a plurality of groups are provided, the groups each including the plurality of radiation element rows arranged at the predetermined pitch in the direction orthogonal to the direction of the radiation element rows, and directions of the radiation element rows in all of the groups are parallel to each other.

9. The antenna according to claim 1, further comprising
an adhesive layer of a dielectric formed between the second dielectric layer and the dielectric substrate so as to coat the radiation elements, to bond the second dielectric layer and the dielectric substrate together, wherein
the adhesive layer is thicker than the radiation elements and thinner than the dielectric substrate.

10. The antenna according to claim 1, wherein
the second dielectric layer is a laminate obtained by laminating a plurality of dielectric layers.
